(19) United States
(12) Patent Application Publication
(10) Pub. No.: US 2025/0355317 A1
(43) Pub. Date: Nov. 20, 2025

(54) REFLECTION MODULE AND CAMERA MODULE INCLUDING REFLECTION MODULE

(71) Applicant: Samsung Electro-Mechanics Co., Ltd., Suwon-si (KR)

(72) Inventors: Young Hwan KWON, Suwon-si (KR); Young Bok YOON, Suwon-si (KR); Jong Woo HONG, Suwon-si (KR)

(73) Assignee: Samsung Electro-Mechanics Co., Ltd., Suwon-si (KR)

(21) Appl. No.: 19/191,527

(22) Filed: Apr. 28, 2025

(30) Foreign Application Priority Data
May 16, 2024 (KR) 10-2024-0064153
Nov. 29, 2024 (KR) 10-2024-0174926

(51) Int. Cl. G03B 5/00; G03B 17/17

(52) U.S. Cl. CPC G03B 5/00; G03B 17/17; G03B 2205/0023; G03B 2205/0069

(57) ABSTRACT

A reflection module includes a housing; a holder disposed in the housing and configured to be rotatable relative to the housing; a first magnetic portion disposed on one surface of the holder; and a second magnetic portion disposed on one surface of the housing and facing the first magnetic portion, wherein both an attractive force and a repulsive force act between the first magnetic portion and the second magnetic portion.

### CROSS-REFERENCE TO RELATED APPLICATIONS

This application claims the benefit under 35 USC 119(a) of Korean Patent Application Nos. 10-2024-0064153 filed on May 16, 2024, and 10-2024-0174926 filed on Nov. 29, 2024, in the Korean Intellectual Property Office, the entire disclosures of which are incorporated herein by reference for all purposes.

### BACKGROUND

### 1. Field

The present disclosure relates to a reflection module and a camera module including a reflection module.

### 2. Description of Background

Recently, a camera module, bending a path of light by disposing a reflection member in front of a lens module, has been adopted in a mobile device.

Additionally, the camera module may have a shake correction function compensating for shaking during image capturing so as to increase resolution. Such a shake correction function may be implemented through a two-axis rotation of the reflection member.

In this case, since the reflection member is disposed in a rotatable state, there may be a problem that the reflection member tilts to one side in a state in which a camera module is turned off.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a reflection module includes a housing; a holder disposed in the housing and configured to be rotatable relative to the housing; a first magnetic portion disposed on one surface of the holder; and a second magnetic portion disposed on one surface of the housing and facing the first magnetic portion, wherein both an attractive force and a repulsive force act between the first magnetic portion and the second magnetic portion.

A gap between the first magnetic portion and the second magnetic portion may change as the holder rotates.

The holder may be further configured to be rotatable about at least two axes perpendicular to a direction in which the first magnetic portion and the second magnetic portion face each other, and perpendicular to each other, as rotation axes.

A position at which the attractive force acts may be closer to a rotation center of the holder than a position at which the repulsive force acts.

The first magnetic portion may include a first magnetic body and a third magnetic body both disposed on the holder, the second magnetic portion may include a second magnetic body disposed on the housing, and each of the first magnetic body, the second magnetic body, and the third magnetic body may be a magnet.

One surface of the first magnetic body and one surface of the second magnetic body may face each other, one surface of the third magnetic body and the one surface of the second magnetic body face may each other, the one surface of the first magnetic body and the one surface of the second magnetic body facing each other may have different polarities, and the one surface of the third magnetic body and the one surface of the second magnetic body facing each other may have a same polarity.

A distance between the one surface of the first magnetic body and the one surface of the second magnetic body may be smaller than a distance between the one surface of the third magnetic body and the one surface of the second magnetic body.

A size of portions of the one surface of the first magnetic body and the one surface of the second magnetic body facing each other may be larger than a size of portions of the one surface of the third magnetic body and the one surface of the second magnetic body facing each other.

A magnitude of the attractive force may greater than a magnitude of the repulsive force.

The first magnetic portion may include a first magnetic body and a third magnetic body both disposed on the holder, the second magnetic portion may include a second magnetic body disposed on the housing, the first magnetic body may be a yoke, each of the second magnetic body and the third magnetic body may be a magnet, and the attractive force may act between the first magnetic body and the second magnetic body, and the repulsive force may act between the third magnetic body and the second magnetic body.

The first magnetic portion may include a first magnetic body disposed on the holder, the second magnetic portion may include a second magnetic body disposed on the housing, each of the first magnetic body and the second magnetic body may be a magnet, one surface of the first magnetic body and one surface of the second magnetic body may face each other, and a number of polarities of the one surface of the first magnetic body and a number of polarities of the one surface of the second magnetic body facing each other may be different from each other.

A first portion of the one surface of the first magnetic body and a first portion of the one surface of the second magnetic body facing each other may have opposite polarities, a second portion of the one surface of the first magnet body and a second portion of the one surface of the second magnetic body facing each other may have a same polarity, and a size of the first portions may be greater than a size of the second portions.

The reflection module may further include a third magnetic portion disposed on another surface of the holder; and a fourth magnetic portion disposed on another surface of the housing and facing the third magnetic portion, wherein a repulsive force may act between the third magnetic portion and the fourth magnetic portion.

A direction in which the first magnetic portion and the second magnetic portion face each other and a direction in which the third magnetic portion and the fourth magnetic portion face each other may be perpendicular to each other.

The reflection module may further include a first ball member disposed between the housing and the holder.

The first magnetic portion may include a first magnetic body disposed on the holder, the second magnetic portion may include a second magnetic body disposed on the housing, and each of the first magnetic body and the second magnetic body may have a ring shape surrounding the first ball member.

A first guide groove may be formed in the holder, a second guide groove may be formed in the housing, and the first ball member may be disposed in three-point contact with the first guide groove and in three-point contact with the second guide groove.

In another general aspect, a camera module includes a housing; a holder disposed in the housing and configured to be rotatable relative to the housing; an optical member coupled to the holder; a support portion disposed in the housing between the housing and the holder and configured to rotatably support the holder; a first magnetic portion disposed on the holder; and a second magnetic portion disposed on the housing and facing the first magnetic portion, wherein a repulsive force acts between the first magnetic portion and the second magnetic portion.

In addition to the repulsive force acting between the first magnetic portion and the second magnetic portion, an attractive force may act between the first magnetic portion and the second magnetic portion, and a position at which the attractive force acts may be closer to a rotation center of the holder than a position at which the repulsive force acts.

The camera module may further include a first driver including a first magnet disposed on the holder and a first coil facing the first magnet; and a second driver including a second magnet disposed on the holder and a second coil facing the second magnet.

The camera module may further include a first lens module coupled to the holder and having a first optical axis, wherein the optical member may be a reflection member, and the first magnetic portion and the second magnetic portion may face each other in a direction of the first optical axis.

In another general aspect, a reflection module includes a housing; a holder disposed in the housing and configured to be rotatable relative to the housing from an original position to perform shake correction; a first magnetic portion disposed on one surface of the holder; and a second magnetic portion disposed on one surface of the housing and facing the first magnetic portion, wherein the first magnetic portion and the second magnetic portion are configured to return the housing to the original position after the shake correction has been performed.

Both an attractive force and a repulsive force may act between the first magnetic portion and the second magnetic portion in a direction in which the first magnetic portion and the second magnetic portion face each other.

The holder may be further configured to be rotatable about at least two axes perpendicular to a direction in which the first magnetic portion and the second magnetic portion face each other, and perpendicular to each other, as rotation axes to perform the shake correction, and a position at which the attractive force acts may be closer to a rotation center of the holder than a position at which the repulsive force acts.

A gap between the first magnetic portion and the second magnetic portion may decrease on one side of the rotation center of the holder as the holder rotates away from the original position during the shake correction, thereby causing the repulsive force to increase on the one side of the holder during the shake correction, and the increased repulsive force may act to return the holder to the original position after the shake correction has been performed.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of the camera module of FIG. 1.

FIG. 3 is an exploded perspective view of a reflection module and a housing.

FIG. 4 is a view of FIG. 3 from a different direction.

FIG. 5 is a perspective view of a reflection module.

FIG. 6 is a view of FIG. 5 from a different direction.

FIG. 7 is an exploded perspective view of a reflection module and a housing.

FIG. 8 is a bottom view of the reflection module of FIG. 7.

FIG. 9 is a plan view of the housing of FIG. 7.

FIGS. 10 and 11 are partial cutaway perspective views of a reflection module.

FIG. 12 is a view illustrating an attractive force and a repulsive force acting between a holder and a housing according to an embodiment.

FIG. 13 is a view illustrating an attractive force and a repulsive force acting between a holder and a housing according to another embodiment.

FIG. 14 is a bottom view of a holder according to another embodiment.

FIG. 15 is a partial cutaway perspective view of a reflection module including the holder of FIG. 14.

FIG. 16 is a view illustrating an attractive force and an repulsive force acting between a holder and a housing according to another embodiment.

FIG. 17 is a view illustrating an attractive force and a repulsive force acting between a holder and a housing according to another embodiment.

FIG. 18 is a view illustrating an attractive force and a repulsive force acting between a holder and a housing according to another embodiment.

FIG. 19 is a view illustrating an attractive force and a repulsive force acting between a holder and a housing according to another embodiment.

FIG. 20 is a view illustrating an attractive force and a repulsive force acting between a holder and a housing according to another embodiment.

FIG. 21 is a bottom view of a holder according to another embodiment.

FIG. 22 is a view illustrating a repulsive force acting on a reflection module.

FIG. 23 is a perspective view illustrating a state in which a second lens module is separated from a camera module according to an embodiment of the present disclosure.

FIG. 24 is a bottom perspective view of the second lens module of FIG. 23.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The present disclosure relates to a reflection module and a camera module including a reflection module, and the camera module may be mounted in a portable electronic device such as a mobile communication terminal, a smartphone, or a tablet PC.

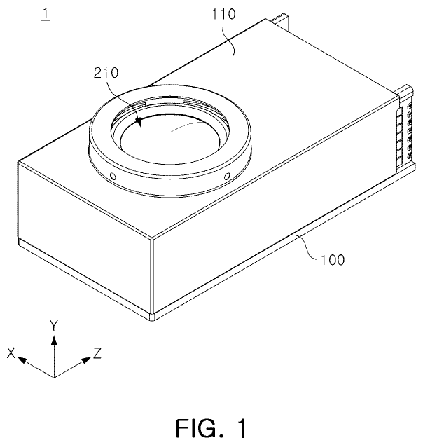

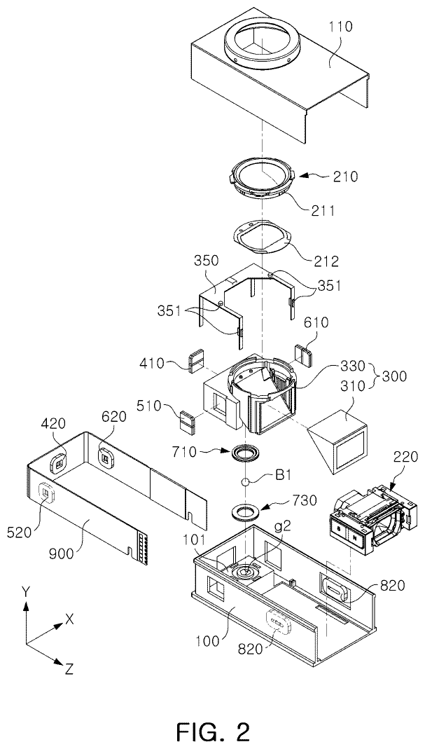

FIG. 1 is a perspective view of a camera module according to an embodiment of the present disclosure, and FIG. 2 is an exploded perspective view of the camera module of FIG. 1.

Referring to FIGS. 1 and 2, a camera module 1 according to an embodiment of the present disclosure may include a reflection module 300 and a housing 100.

The reflection module 300 may be disposed within the housing 100 and includes a reflection member 310 having a reflective surface.

The reflection module 300 may be rotatably disposed with respect to at least two different axes for shake correction. For example, the reflection module 300 may be rotated about three axes perpendicular to each other. For another example, the reflection module 300 may be rotated about two axes perpendicular to each other.

In an embodiment, the camera module 1 may further include a first lens module 210.

The first lens module 210 includes at least one lens, and the at least one lens has a first optical axis (Y-axis). The first optical axis (Y-axis) may extend in an up-down direction in FIG. 2. The first optical axis (Y-axis) may pass through a center of the at least one lens of the first lens module 210.

In an embodiment, the first lens module 210 includes at least one lens and a first lens barrel 211. At least one lens may be disposed in the first lens barrel 211, and the first lens barrel 211 may be coupled to the reflection module 300.

Alternatively, the first lens module 210 may include only the at least one lens, and a form in which the at least one lens is coupled to the reflection module 300 is also possible.

The first lens module 210 may be disposed in front of the reflection module 300. Here, “front” may mean in a positive first optical axis (Y-axis) direction (+Y-axis direction) with respect to the reflection module 300. For example, the first lens module 210 may be disposed above the reflection module 300 in the first optical axis (Y-axis) direction.

The first lens module 210 may be coupled to the reflection module 300. For example, the first lens barrel 211 of the first lens module 210 may be coupled to a holder 330 of the reflection module 300.

The first lens module 210 and the reflection module 300 are disposed in the housing 100.

In an embodiment, the camera module 1 may further include a second lens module 220. The reflection module 300 is disposed between the first lens module 210 and the second lens module 220. The second lens module 220 includes a plurality of lenses and has a second optical axis (Z-axis). The plurality of lenses are disposed along the second optical axis (Z-axis). The second optical axis (Z-axis) may pass through a center of the plurality of lenses of the second lens module 220.

The first optical axis (Y-axis) of the first lens module 210 and the second optical axis (Z-axis) of the second lens module 220 may be perpendicular to each other.

The first lens module 210 includes one or more lenses, and the second lens module 220 includes a plurality of lenses.

One or more lenses of the first lens module 210 may be circular when viewed in the first optical axis (Y-axis) direction. At least one lens of the plurality of lenses of the second lens module 220 may be non-circular when viewed in a second optical axis (Z-axis) direction. For example, a non-circular lens may have different lengths in two directions perpendicular to the second optical axis (Z-axis) direction, and perpendicular to each other. In an embodiment, in the non-circular lens, a length in a first axis (X-axis) direction perpendicular to both the first optical axis (Y-axis) direction and the second optical axis (Z-axis) direction is longer than a length in the first optical axis (Y-axis) direction.

The first lens module 210 and the reflection module 300 may be configured to rotate together for shake correction. The second lens module 220 may be moved in the second optical axis (Z-axis) direction for focus adjustment.

The camera module 1 may further include an image sensor module (not shown). The image sensor module may be disposed at the rear of the second lens module 220. When the camera module 1 does not include the second lens module 220, the image sensor module may be disposed at the rear of the reflection module 300.

The image sensor module may include a sensor housing, an image sensor, and a printed circuit board, and may further include an infrared blocking filter.

The infrared blocking filter may be mounted on the sensor housing. The infrared blocking filter blocks light in the infrared region among the light passing through the second lens module.

The printed circuit board is coupled with the sensor housing, and an image sensor is disposed on the printed circuit board.

The light passing through the second lens module 220 is received by the image sensor module (e.g., an image sensor).

The camera module 1 may further include a case 110. The case 110 is coupled with the housing 100 so as to cover an upper portion of the housing 100. The case 110 has an opening, and the first lens module 210 may be disposed in the opening.

At least a portion of the first lens module 210 may be disposed to protrude outside the housing 100 and the case 110.

In this embodiment, it is described that the reflection module 300, the first lens module 210, and the second lens module 220 are all disposed in one housing 100, but a first housing in which the reflection module 300 is disposed and a second housing in which each lens module is disposed may be provided as separate components.

In this case, the first housing may be included as a component of the reflection module 300.

In this embodiment, it is described that the reflection member 310 and the first lens module 210 are coupled to the holder 330, but only one of the reflection member 310 and the first lens module 210 may be coupled to the holder 330. In this case, the reflection member 310 or the first lens module 210 coupled to the holder 330 may be referred to as an optical member.

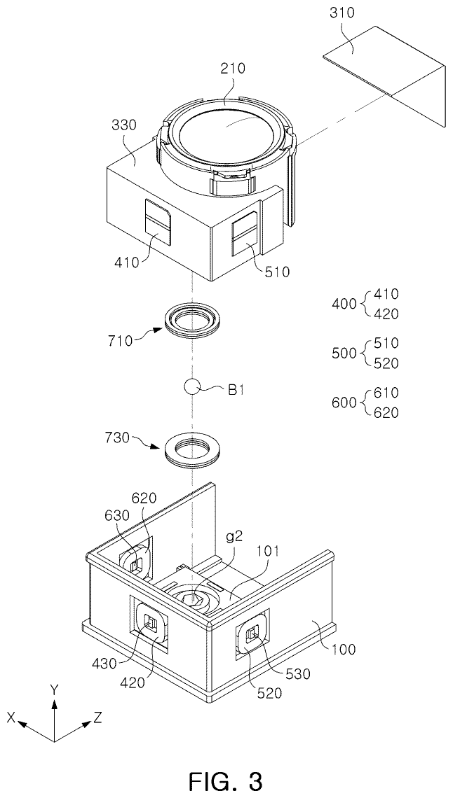

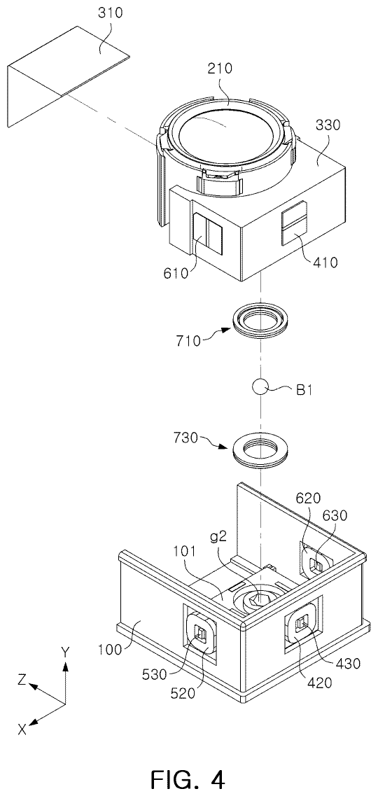

FIG. 3 is an exploded perspective view of a reflection module and a housing, and FIG. 4 is a view of FIG. 3 from a different direction.

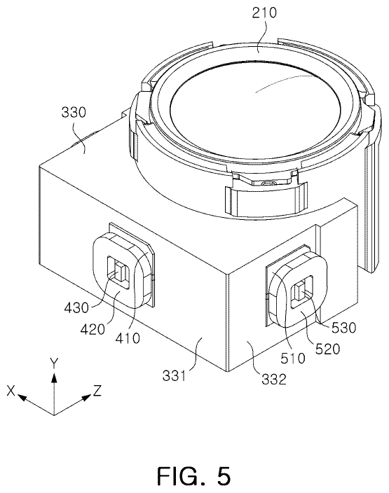

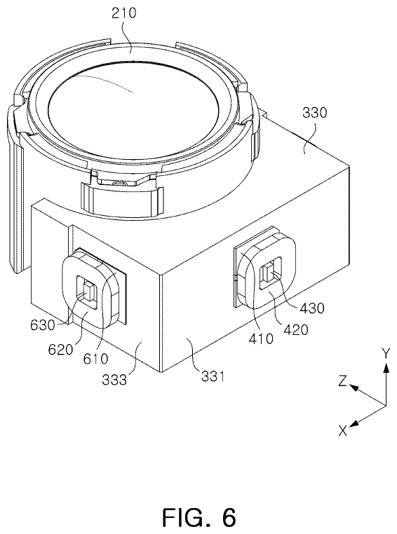

Additionally, FIG. 5 is a perspective view of a reflection module, and FIG. 6 is a view of FIG. 5 from a different direction.

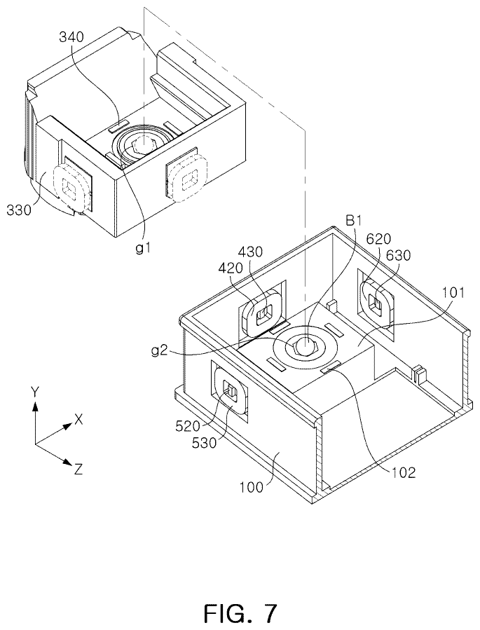

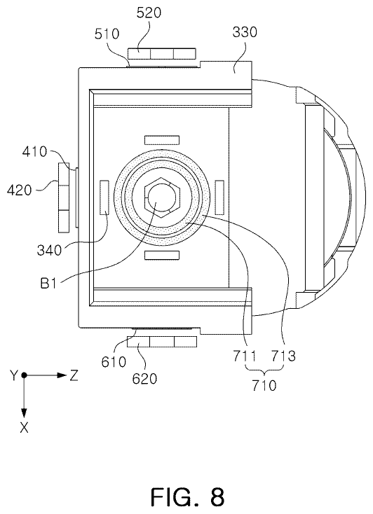

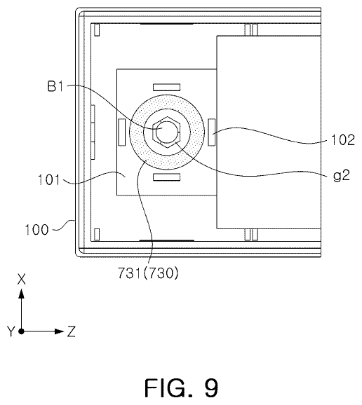

Additionally, FIG. 7 is an exploded perspective view of a reflection module and a housing, FIG. 8 is a bottom view of the reflection module of FIG. 7, and FIG. 9 is a plan view of the housing of FIG. 7.

Referring to FIGS. 3 to 9, a reflection module 300 includes a reflection member 310 and a holder 330.

The reflection member 310 has a reflective surface reflecting light passing through the first lens module 210. For example, the reflection member 310 may be a prism or a mirror.

When the reflection member 310 is a prism, the reflection member 310 may have any shape obtained by dividing a rectangular solid (or a cube) into two halves in a diagonal direction. The prism includes an incident surface on which light is incident, a reflective surface reflecting light passing through the incident surface, and an exit surface from which light reflected from the reflective surface is emitted.

The reflection member 310 is mounted on a holder 330. A first lens module 210 may be disposed in front of the reflection member 310. In an embodiment, the first lens module 210 may be mounted on the holder 330.

The holder 330 is rotatably disposed in the housing 100.

The holder 330 may be rotated about a first axis (X-axis) perpendicular to both the first optical axis (Y-axis) and the second optical axis (Z-axis). For example, the holder 330 may be rotated relative to the housing 100 about the first axis (X-axis) as a rotation axis. At this time, the first lens module 210 may be rotated along with the holder 330. The first axis (X-axis) may also be referred to as a first rotation axis.

The holder 330 may be rotated about the second optical axis (Z-axis) as a rotation axis. For example, the holder 330 may be rotated relative to the housing 100 about the second optical axis (Z-axis) as a rotation axis. In this case, the first lens module 210 may be rotated along with the holder 330. The second optical axis (Z-axis) may also be referred to as a second rotation axis.

The holder 330 may be rotated about the first optical axis (Y-axis) as a rotation axis. For example, the holder 330 may be rotated relative to the housing 100 about the first optical axis (Y-axis) as a rotation axis. In this case, the first lens module 210 may also be rotated along with the holder 330. The first optical axis (Y-axis) may also be referred to as a third rotation axis.

The reflection module 300 may further include a first driver 400. The holder 330 may be rotated about the first axis (X-axis) as a rotation axis by the first driver 400.

The first driver 400 includes a first magnet 410 and a first coil 420. The holder 330 may be rotated relative to the housing 100 about the first axis (X-axis) as a rotation axis by the first driver 400. Since the first lens module 210 is disposed in the holder 330, the first lens module 210 may also be rotated along with the holder 330.

The first magnet 410 may be mounted on the holder 330. For example, the first magnet 410 may be mounted on a first side surface 331 of the holder 330. The first side surface 331 of the holder 330 may be a side surface of the holder 330 facing the housing 100 in the second optical axis (Z-axis) direction.

The first magnet 410 may be magnetized so that one surface (for example, a surface facing the first coil 420) has both an N-pole and an S-pole. In an embodiment, a surface of the first magnet 410 facing the first coil 420 may be provided with an N-pole, a neutral region, and an S-pole sequentially arranged in the first optical axis (Y-axis) direction.

The first coil 420 may be disposed to face the first magnet 410. In an embodiment, the first coil 420 may be disposed to face the first magnet 410 in the second optical axis (Z-axis) direction.

The first coil 420 is disposed on a substrate 900, and the substrate 900 is mounted on the housing 100 so that the first magnet 410 and the first coil 420 face each other in the second optical axis (Z-axis) direction.

The housing 100 may be provided with a through-hole penetrating through the housing 100 in the second optical axis (Z-axis) direction, and the first coil 420 may be disposed in the through-hole to directly face the first magnet 410.

In the shake correction, the first magnet 410 is a movable member mounted on the holder 330 and rotated, and the first coil 420 is a fixed member fixed to the substrate 900.

When power is applied to the first driver 400, the first driver 400 may generate a driving force required to rotate the holder 330 about the first axis (X-axis) as a rotation axis. For example, the first driver 400 may generate a driving force in the first optical axis (Y-axis) direction.

The reflection module 300 may further include a second driver 500. The holder 330 may be rotated about the second optical axis (Z-axis) as a rotation axis by the second driver 500.

The second driver 500 includes a second magnet 510 and a second coil 520. The holder 330 may be rotated relative to the housing 100 about the second optical axis (Z-axis) as a rotation axis by the second driver 500. Since the first lens module 210 is disposed in the holder 330, the first lens module 210 may also be rotated along with the holder 330.

The second magnet 510 may be mounted on the holder 330. For example, the second magnet 510 may be mounted on a second side surface 332 of the holder 330. The second side surface 332 of the holder 330 may be a side surface of the holder 330 facing the housing 100 in the first axis (X-axis) direction.

The second side surface 332 of the holder 330 may be a plane perpendicular to the first side surface 331 of the holder 330.

The second magnet 510 may be magnetized so that one surface (e.g., a surface facing the second coil 520) has both an N-pole and an S-pole. In an embodiment, the one surface of the second magnet 510 facing the second coil 520 may be provided with an N-pole, a neutral region, and an S-pole sequentially arranged in the first optical axis (Y-axis) direction.

The second coil 520 may be disposed to face the second magnet 510. In an embodiment, the second coil 520 may be disposed to face the second magnet 510 in the first axis (X-axis) direction.

The second coil 520 is disposed on the substrate 900, and the substrate 900 is mounted on the housing 100 so that the second magnet 510 and the second coil 520 face each other in the first axis (X-axis) direction.

The housing 100 is provided with a through-hole penetrating through the housing 100 in the first axis (X-axis) direction, and the second coil 520 is disposed in the through-hole so as to directly face the second magnet 510.

When the shake correction is performed, the second magnet 510 is a movable member mounted on the holder 330 and rotated, and the second coil 520 is a fixed member fixed to the substrate 900.

When power is applied to the second driver 500, the second driver 500 may generate a driving force required to rotate the holder 330 about the second optical axis (Z-axis) as a rotation axis. For example, the second driver 500 may generate a driving force in the first optical axis (Y-axis) direction.

The reflection module 300 may further include a third driver 600. The holder 330 may be rotated about the first optical axis (Y-axis) as a rotation axis by the third driver 600.

The third driver 600 includes a third magnet 610 and a third coil 620. The holder 330 may be rotated relative to the housing 100 about the first optical axis (Z-axis) as a rotation axis by the third driver 600. Since the first lens module 210 is disposed in the holder 330, the first lens module 210 may also be rotated along with the holder 330.

The third magnet 610 may be mounted on the holder 330. For example, the third magnet 610 may be mounted on a third side surface 333 of the holder 330. The third side surface 333 of the holder 330 may be a side surface of the holder 330 facing the housing 100 in the first axis (X-axis) direction.

The third side surface 333 of the holder 330 may be perpendicular to the first side surface 331 of the holder 330. Additionally, the second side surface 332 of the holder 330 and the third side surface 333 of the holder 330 may be paced apart from each other in the first axis (X-axis) direction.

The third magnet 610 may be magnetized so that one surface (e.g., a surface facing the third coil 620) has both an N-pole and an S-pole. In an embodiment, the one surface of the third magnet 610 facing the third coil 620 may be provided with an N-pole, a neutral region, and an S-pole sequentially arranged in the second optical axis (Z-axis) direction.

The third coil 620 may be disposed to face the third magnet 610. In an embodiment, the third coil 620 may be disposed to face the third magnet 610 in the first axis (X-axis) direction.

The third coil 620 is disposed on the substrate 900, and the substrate 900 is mounted on the housing 100 so that the third magnet 610 and the third coil 620 face each other in the first axis (X-axis) direction.

The housing 100 is provided with a through-hole penetrating through the housing 100 in the first axis (X-axis) direction, and the third coil 620 may be disposed in the through-hole to directly face the third magnet 610.

In the shake correction, the third magnet 610 is a movable member that is mounted on the holder 330 and rotated, and the third coil 620 is a fixed member fixed to the substrate 900.

When power is applied to the third driver 600, the third driver 600 may generate a driving force required to rotate the holder 330 about the first optical axis (Y-axis) as a rotation axis. For example, the third driver 600 may generate a driving force in the second optical axis (Z-axis) direction.

A support portion may be disposed between the holder 330 and the housing 100. The support portion may rotatably support the holder 330.

In an embodiment, the support portion may be a first ball member B1. The first ball member B1 may be disposed between the holder 330 and the housing 100 to form a center of rotation of the holder 330.

An intersection of three rotation axes perpendicular to each other may be formed within the support portion. For example, a rotation center of the holder 330 may be formed in the first ball member B1.

The first ball member B1 may be in the shape of a ball. For example, the first ball member B1 may be a single ball.

The holder 330 may be pivotally supported and rotated by the first ball member B1. For example, the holder 330 may be freely rotated in a state of being supported by the first ball member B1. In an embodiment, the holder 330 may be rotated about three rotation axes perpendicular to each other.

A virtual plane obtained by extending the neutral region of the first magnet 410 in the second optical axis (Z-axis) direction may pass through the first ball member B1.

A virtual plane obtained by extending the neutral region of the second magnet 510 in the first axis (X-axis) direction may pass through the first ball member B1.

A virtual plane obtained by extending the neutral region of the third magnet 610 in the first axis (X-axis) direction may pass through the first ball member B1.

In an embodiment, the first magnet 410 and the first coil 420 may be spaced apart from the first ball member B1 in the second optical axis (Z-axis) direction. When a driving force is generated in the first optical axis (Y-axis) direction by the first magnet 410 and the first coil 420, the holder 330 may be rotated about a rotation axis (e.g., the first axis (X-axis)) formed by the first ball member B1.

In an embodiment, the second magnet 510 and the second coil 520 may be spaced apart from the first ball member B1 in the first axis (X-axis) direction. When a driving force is generated in the first optical axis (Y-axis) direction by the second magnet 510 and the second coil 520, the holder 330 may be rotated about a rotation axis (e.g., the second optical axis (Z-axis)) formed by the first ball member B1.

In an embodiment, the third magnet 610 and the third coil 620 may be spaced apart from the first ball member B1 in the first axis (X-axis) direction. When a driving force is generated in the second optical axis (Z-axis) direction by the third magnet 610 and the third coil 620, the holder 330 may be rotated about a rotation axis (e.g., the first optical axis (Y-axis)) formed by the first ball member B1.

Although not illustrated in the drawings, the support portion may be provided as a protrusion protruding from the housing 100 toward the holder 330. In this case, an end of the protrusion (e.g., a portion in contact with the holder 330) may be curved. For example, the end of the protrusion may be in the shape of a hemisphere or a sphere. When the support portion is a protrusion protruding from the housing 100, a guide groove accommodating the protrusion may be formed in the holder 330.

In another embodiment, the support portion may also be provided as a protrusion protruding from the holder 330 toward the housing 100. In this case, an end of the protrusion (e.g., a portion in contact with the housing 100) may be curved. For example, the end of the protrusion may be hemispherical or spherical. When the support portion is a protrusion protruding from the holder 330, a guide groove accommodating the protrusion may be formed in the housing 100.

A first guide groove g1 and a second guide groove g2 may be formed in surfaces of the holder 330 and the housing 100 facing each other (for example, surfaces facing each other in the first optical axis (Y-axis) direction). For example, the first guide groove g1 may be formed in the holder 330, and the second guide groove g2 may be formed in the housing 100. The first guide groove g1 and the second guide groove g2 may face each other in the first optical axis (Y-axis) direction.

The first ball member B1 may be disposed between the first guide groove g1 and the second guide groove g2 to form rotation axes of the holder 330.

Each of the first guide groove g1 and the second guide groove g2 may be in three-point contact with the first ball member B1.

In an embodiment, the housing 100 may include a protrusion portion 101. The protrusion portion 101 may protrude in the first optical axis (Y-axis) direction from an inner bottom surface of the housing 100. The second guide groove g2 may be formed in an upper surface of the protrusion portion 101.

An attractive force may act between the housing 100 and the holder 330. For example, a first magnetic portion 710 may be disposed on one of the housing 100 and the holder 330, and a second magnetic portion 730 may be disposed on the other one thereof.

In an embodiment, the first magnetic portion 710 may include a first magnetic body 711 disposed on the holder 330, and the second magnetic portion 730 may include a second magnetic body 731 disposed on the housing 100.

The first magnetic body 711 and the second magnetic body 731 may face each other in the first optical axis (Y-axis) direction.

In an embodiment, the first magnetic body 711 may be disposed on a lower surface of the holder 330, and the second magnetic body 731 may be disposed on an upper surface of the protrusion portion 101 of the housing 100.

Planar shapes of the first magnetic body 711 and the second magnetic body 731 may include a curve.

In an embodiment, the first magnetic body 711 may have a closed curve shape surrounding the first guide groove g1. Additionally, the second magnetic body 731 may have a closed curve shape surrounding the second guide groove g2.
an attractive force may act between the first magnetic body 711 and the second magnetic body 731.

In an embodiment, each of the first magnetic body 711 and the second magnetic body 731 may be a magnet.

One surface of the first magnetic body 711 and one surface of the second magnetic body 731 may face each other in the first optical axis (Y-axis) direction, and a polarity of the one surface of the first magnetic body 711 and a polarity of the one surface of the second magnetic body 731 may be opposite to each other.

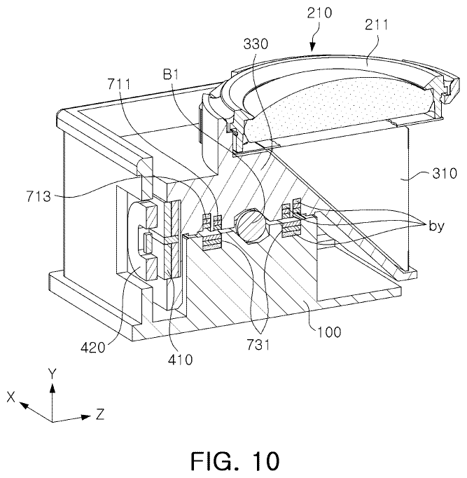

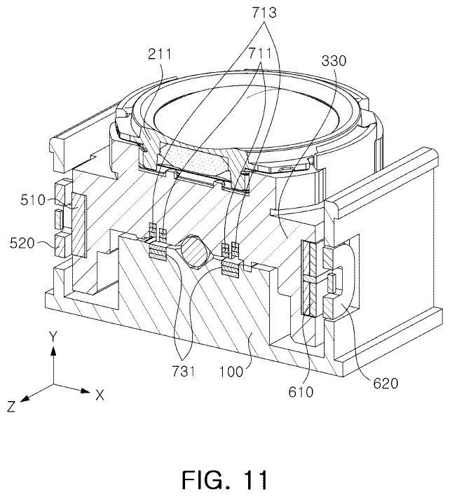

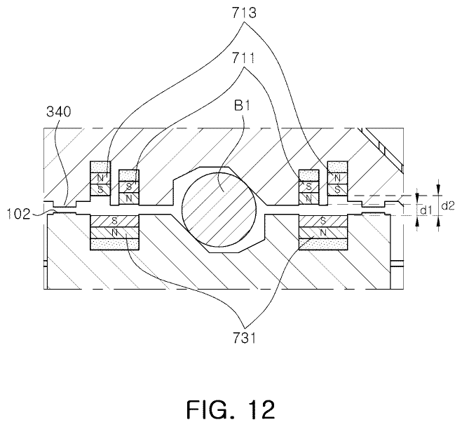

FIG. 10 and FIG. 11 are partial cutaway perspective views of a reflection module, and FIG. 12 is a view illustrating an attractive force and a repulsive force acting between a holder and a housing according to an embodiment.

The first magnetic portion 710 further includes a third magnetic body 713. In an embodiment, the first magnetic portion 710 includes a first magnetic body 711 and a third magnetic body 713, and the second magnetic portion 730 includes a second magnetic body 731.

The first magnetic body 711 may be disposed on the holder 330, the second magnetic body 731 may be disposed on the housing 100, and the third magnetic body 731 may be disposed on the holder 330. That is, both the first magnetic body 711 and the third magnetic body 713 may be disposed on the holder 330, and the second magnetic body 731 may be disposed on the housing 100.

In the embodiment illustrated in FIGS. 10 to 12, each of the first magnetic body 711, the second magnetic body 731, and the third magnetic body 713 may be a magnet.

Additionally, each of the first magnetic body 711, the second magnetic body 731, and the third magnetic body 713 may have a ring shape.

One surface of the first magnetic body 711 and one surface of the second magnetic body 731 may be disposed to face each other in the first optical axis (Y-axis) direction, and each of the one surface of the first magnetic body 711 and the one surface of the second magnetic body 731 facing each other may have one polarity.

A polarity of the one surface of the first magnetic body 711 and a polarity of the one surface of the second magnetic body 731 facing each other may be opposite to each other. For example, when the one surface of the first magnetic body 711 has a first polarity, the one surface of the second magnetic body 731 may have a second polarity.

The first polarity and the second polarity are opposite polarities, and when the first polarity is an N-pole, the second polarity may be an S-pole.

Accordingly, an attractive force may act between the first magnetic body 711 disposed on the holder 330 and the second magnetic body 731 disposed on the housing 100. The attractive force may act in the first optical axis (Y-axis) direction.

One surface of the third magnetic body 713 and one surface of the second magnetic body 731 are disposed to face each other in the first optical axis (Y-axis) direction, and the one surface of the third magnetic body 713 facing the one surface of the second magnetic body may have one polarity.

A polarity of the one surface of the third magnetic body 713 and a polarity of the one surface of the second magnetic body 731 facing each other may be the same. For example, when the one surface of the second magnetic body 731 has a second polarity, the one surface of the third magnetic body 713 may also have the second polarity.

Accordingly, a repulsive force may act between the third magnetic body 713 disposed on the holder 330 and the second magnetic body 731 disposed on the housing 100. The repulsive force may act in the first optical axis (Y-axis) direction.

A position at which the attractive force acts may be closer to the first ball member B1 (i.e., the intersection of the plurality of rotation axes) than a position at which the repulsive force acts.

For example, the first magnetic body 711 may be disposed closer to the first ball member B1 than the third magnetic body 713.

Accordingly, in the reflection module 300 according to an embodiment of the present disclosure, not only an attractive force but also a repulsive force is generated between the holder 330 and the housing 100.

When a distance between the second magnetic body 731 and the third magnetic body 713 decreases due to the rotation of the holder 330 during the shake correction, the repulsive force between the second magnetic body 731 and the third magnetic body 713 increases, thereby causing the holder 330 to return to an original position when power is not applied to the reflection module 300.

Here, the original position refers to a state in which the holder 330 is not rotated about the second optical axis (Z-axis) and the first axis (X-axis), for example, a state in which the first magnetic body 711 (or the third magnetic body 713) and the second magnetic body 731 are parallel to each other.

That is, the reflection module 300 according to an embodiment of the present disclosure may reduce power consumption for positioning the holder 330 by mechanically implementing a centering structure of the holder 330.

Accordingly, in a case in which the shake correction is not required (for example, when power is not supplied to the reflection module 300), a position of the holder 330 may be adjusted without separate power consumption.

In this manner, both an attractive force and an repulsive force may be generated between the first magnetic portion 710 and the second magnetic portion 730.

Since the first magnetic portion 710 is disposed on the holder 330 and the second magnetic portion 730 is disposed on the housing 100, both an attractive force and a repulsive force may be generated between the holder 330 and the housing 100.

Additionally, a magnitude of the attractive force between the holder 330 and the housing 100 may be greater than a magnitude of the repulsive force between the holder 330 and the housing 100.

Accordingly, the first ball member B1 may be held in contact with the holder 330 and the housing 100.

A distance d1 between the first magnetic body 711 and the second magnetic body 731 may be different from a distance d2 between the third magnetic body 713 and the second magnetic body 731.

For example, the distance d1 in the first optical axis (Y-axis) direction between one surface of the first magnetic body 711 and one surface of the second magnetic body 731 may be smaller than the distance d2 in the first optical axis (Y-axis) direction between one surface of the third magnetic body 713 and one surface of the second magnetic body 731.

Accordingly, the magnitude of the attractive force acting between the first magnetic body 711 and the second magnetic body 731 may be greater than the magnitude of the repulsive force acting between the third magnetic body 713 and the second magnetic body 731.

Although it has been described that the first magnetic body 711 and the third magnetic body 713 are disposed on the holder 330 and the second magnetic body 731 is disposed on the housing 100, in another embodiment, the first magnetic body 711 and the third magnetic body 713 may be disposed on the housing 100 and the second magnetic body 731 may be disposed on the holder 330.

Referring to FIG. 10, a back yoke (by) may be disposed between the first magnetic body 711 and the holder 330. In an embodiment, the other surface of the first magnetic body 711 (i.e., the opposite surface of the one surface of the first magnetic body 711 facing the one surface of the second magnetic body 731) may be in contact with the back yoke (by). A magnetic field of the first magnetic body 711, which is a magnet, may be prevented from leaking by the back yoke (by).

A back yoke (by) may be disposed between the second magnetic body 731 and the housing 100. In an embodiment, the other surface of the second magnetic body 731 (i.e., an opposite surface of the one surface of the second magnetic body 731 of the second magnetic body 731) may be in contact with the back yoke (by). A magnetic field of the second magnetic body 731, which is a magnet, may be prevented from leaking by the back yoke (by).

A back yoke (by) may be disposed between the third magnetic body 713 and the holder 330. In an embodiment, the other surface of the third magnetic body 713 (i.e., an opposite surface of the one surface of the third magnetic body 713 facing the one surface of the second magnetic body 731) may be in contact with the back yoke (by). The magnetic field of the third magnetic body 713, which is a magnet, may be prevented from leaking by the back yoke (by).

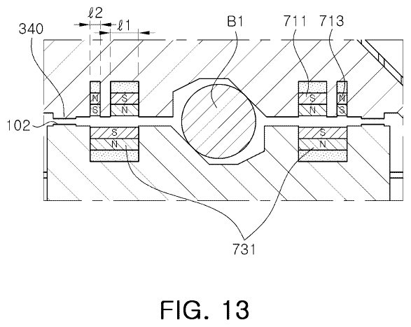

FIG. 13 is a view illustrating an attractive force and a repulsive force acting between the holder and the housing according to another embodiment.

An embodiment illustrated in FIG. 13 is different from an embodiment illustrated in FIG. 12 in sizes of the first magnetic body 711 and the third magnetic body 713.

In an embodiment illustrated in FIG. 13, each of the first magnetic body 711, the second magnetic body 731, and the third magnetic body 713 may be a magnet.

One surface of the first magnetic body 711 and one surface of the second magnetic body 731 are disposed to face each other in the first optical axis (Y-axis) direction, and each of the one surface of the first magnetic body 711 and the one surface of the second magnetic body 731 may have one polarity.

Here, a polarity of the one surface of the first magnetic body 711 and a polarity of the one surface of the second magnetic body 731 facing each other may be opposite to each other. For example, when the one surface of the first magnetic body 711 has a first polarity, the one surface of the second magnetic body 731 may have a second polarity.

Here, the first polarity and the second polarity are opposite polarities, and when the first polarity is an N-pole, the second polarity may be an S-pole. Accordingly, an attractive force may act between the first magnetic body 711 disposed on the holder 330 and the second magnetic body 731 disposed on the housing 100.

One surface of the third magnetic body 713 and one surface of the second magnetic body 731 are disposed to face each other in the first optical axis (Y-axis) direction, and the one surface of the third magnetic body 713 may have one polarity.

Here, a polarity of the one surface of the third magnetic body 713 and a polarity of the one surface of the second magnetic body 731 facing each other may be the same. For example, when the one surface of the second magnetic body 731 has the second polarity, the one surface of the third magnetic body 713 may also have the second polarity.

Accordingly, a repulsive force may act between the third magnetic body 713 disposed on the holder 330 and the second magnetic body 731 disposed on the housing 100.

A size of portions of the first magnetic body 711 and the second magnetic body 731 facing each other may be different from a size of portions of the third magnetic body 713 and the second magnetic body 731 facing each other.

For example, a size of portions of the one surface of the first magnetic body 711 and the one surface of the second magnetic body 731 facing each other may be larger than a size of portions of the one surface of the third magnetic body 713 and the one surface of the second magnetic body 731 facing each other.

In other words, a size of portions of opposite polarities facing each other may be larger than a size of portions of the same polarity facing each other.

A length l1 of portions of the one surface of the first magnetic body 711 and the one surface of the second magnetic body 731 facing each other may be different from a length l2 of portions of the one surface of the third magnetic body 713 and the one surface of the second magnetic body 731 facing each other.

For example, the length l1 of portions of the one surface of the first magnetic body 711 and the one surface of the second magnetic body 731 facing each other may be greater than the length l2 of portions of the one surface of the third magnetic body 713 and the one surface of the second magnetic body 731 facing each other. Here, the lengths l1 and l2 are lengths in a direction perpendicular to the first optical axis (Y-axis).

Accordingly, a magnitude of the attractive force acting between the first magnetic body 711 and the second magnetic body 731 may be greater than a magnitude of the repulsive force acting between the third magnetic body 713 and the second magnetic body 731.

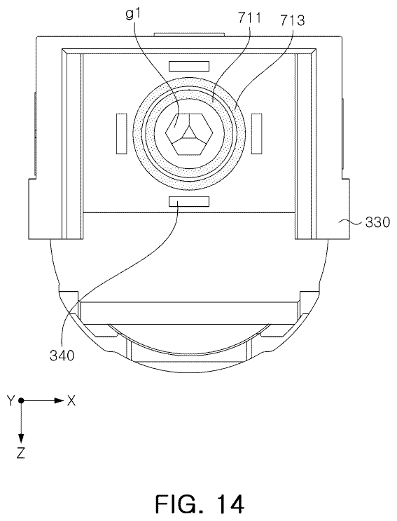

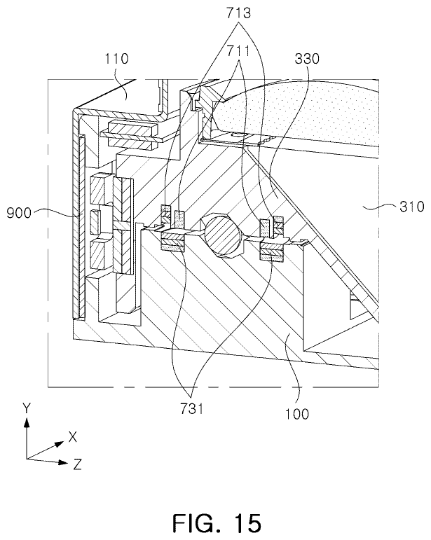

FIG. 14 is a bottom view of a holder according to another embodiment, and FIG. 15 is a partial cutaway perspective view of a reflection module including the holder of FIG. 14.

Referring to FIGS. 14 and 15, there is a difference in the structure for generating an attractive force and a repulsive force between the holder 330 and the housing 100 compared to the embodiment illustrated in FIG. 12.

In an embodiment illustrated in FIGS. 14 and 15, the first magnetic body 711 may be a yoke, and each of the second magnetic body 731 and the third magnetic body 713 may be a magnet.

One surface of the first magnetic body 711 and one surface of the second magnetic body 731 may be disposed to face each other in the first optical axis (Y-axis) direction, and the one surface of the second magnetic body 731 may have one polarity (a first polarity or a second polarity).

Accordingly, an attractive force may act between the first magnetic body 711 disposed on the holder 330 and the second magnetic body 731 disposed on the housing 100.

One surface of the third magnetic body 713 and one surface of the second magnetic body 731 may be disposed to face each other in the first optical axis (Y-axis) direction, and the one surface of the third magnetic body 713 may have one polarity.

Here, the polarity of the one surface of the third magnetic body 713 and the polarity of the one surface of the second magnetic body 731 facing each other may be the same. For example, when the one surface of the second magnetic body 731 has the first polarity, the one surface of the third magnetic body 713 may also have the first polarity. Alternatively, when the one surface of the second magnetic body 731 has the second polarity, the one surface of the third magnetic body 713 may also have the second polarity.

Accordingly, a repulsive force may act between the third magnetic body 713 disposed on the holder 330 and the second magnetic body 731 disposed on the housing 100.

A distance between the one surface of the first magnetic body 711 and the one surface of the second magnetic body 731 facing each other may be different from a distance between the one surface of the third magnetic body 713 and the one surface of the second magnetic body 731 facing each other.

For example, a distance in the first optical axis (Y-axis) direction between the one surface of the first magnetic body 711 and the one surface of the second magnetic body 731 facing each other may be smaller than a distance in the first optical axis (Y-axis) direction between the one surface of the third magnetic body 713 and the one surface of the second magnetic body 731 facing each other.

Accordingly, a magnitude of the attractive force acting between the first magnetic body 711 and the second magnetic body 731 may be greater than a magnitude of the repulsive force acting between the third magnetic body 713 and the second magnetic body 731.

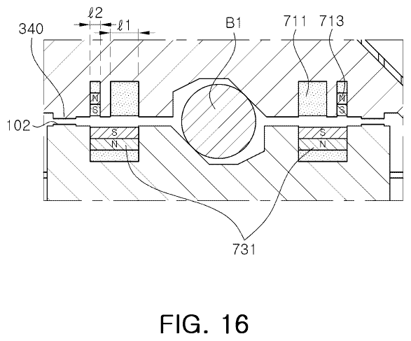

FIG. 16 is a view illustrating an attractive force and a repulsive force acting between a holder and a housing according to another embodiment.

An embodiment illustrated in FIG. 16 has a difference in sizes of the first magnetic body 711 and the third magnetic body 713 compared to the embodiment illustrated in FIG. 15.

In the embodiment illustrated in FIG. 16, the first magnetic body 711 may be a yoke, and each of the second magnetic body 731 and the third magnetic body 713 may be a magnet.

A size of portions of the first magnetic body 711 and the second magnetic body 731 facing each other may be different from a size of portions of the third magnetic body 713 and the second magnetic body 731 facing each other.

For example, a size of portions of one surface of the first magnetic body 711 and one surface of the second magnetic body 731 facing each other may be larger than a size of portions of one surface of the third magnetic body 713 and one surface of the second magnetic body 731 facing each other.

That is, a size of portions in which the attractive force acts may be larger than a size of portions in which the repulsive force acts.

A length l1 of portions of the one surface of the first magnetic body 711 and the one surface of the second magnetic body 731 facing each other may be different from a length l2 of portions of the one surface of the third magnetic body 713 and the one surface of the second magnetic body 731 facing each other.

For example, the length l1 of portions of the one surface of the first magnetic body 711 and the one surface of the second magnetic body 731 facing each other may be greater than the length l2 of portions of the one surface of the third magnetic body 713 and the one surface of the second magnetic body 731 facing each other. Here, the lengths l1 and l2 are lengths in a direction perpendicular to the first optical axis (Y-axis).

Accordingly, a magnitude of the attractive force acting between the first magnetic body 711 and the second magnetic body 731 may be greater than a magnitude of the repulsive force acting between the third magnetic body 713 and the second magnetic body 731.

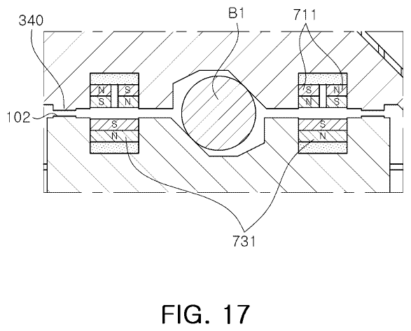

FIG. 17 is a view illustrating an attractive force and a repulsive force acting between a holder and a housing according to another embodiment.

Referring to FIG. 17, there is a difference in the structure for generating the attractive force and the repulsive force between the holder 330 and the housing 100 compared to the embodiment illustrated in FIG. 12.

The first magnetic portion 710 includes a first magnetic body 711, and the second magnetic portion 730 includes a second magnetic body 731. The first magnetic body 711 may be disposed on the holder 330, and the second magnetic body 731 may be disposed the housing 100.

In an embodiment illustrated in FIG. 17, each of the first magnetic body 711 and the second magnetic body 731 may be a magnet.

One surface of the first magnetic body 711 and one surface of the second magnetic body 731 may be disposed to face each other in the first optical axis (Y-axis) direction.

A number of polarities of the one surface of the first magnetic body 711 and a number of polarities of the one surface of the second magnetic body 731 facing each other may be different from each other.

In an embodiment, the first magnetic body 711 may be a polarized magnet in which the one surface of the first magnetic body 711 facing the one surface of the second magnetic body 731 has a plurality of polarities. That is, a plurality of polarities including opposite polarities may be formed on the one surface of the first magnetic body 711 facing the one surface of the second magnetic body 731. The second magnetic body 731 may be a unipolar magnet in which the one surface of the second magnetic body 731 facing the one surface of the first magnetic body 711 has one polarity.

For example, the one surface of the first magnetic body 711 facing the one surface of the second magnetic body 731 is magnetized to have both a first polarity and a second polarity, and the one surface of the second magnetic body 731 facing the one surface of the first magnetic body 711 is magnetized to have one polarity (the first polarity or the second polarity).

In an embodiment, the one surface of the first magnetic body 711 facing the one surface of the second magnetic body 731 has the first polarity in a portion closer to the first ball member B1 (i.e., the intersection of the plurality of rotation axes), and has the second polarity in a portion farther from the first ball member B1. Additionally, the one surface of the second magnetic body 731 facing the one surface of the first magnetic body 711 has the second polarity.

Accordingly, the region in which the attractive force is generated may be an inner region among the portions of the one surface of the first magnetic body 711 and the one surface of the second magnetic body 731 facing each other, and a region in which the repulsive force is generated may be an outer region among the portions of the one surface of the first magnetic body 711 and the one surface of the second magnetic body 731 facing other.

Although not shown in FIG. 17, on the one surface of the first magnetic body 711 facing the one surface of the second magnetic body 713, a length of the portion having the first polarity in a direction perpendicular to the first optical axis (Y-axis) may be greater than a length of the portion having the second polarity in the direction perpendicular to the first optical axis (Y-axis).

Also, although not shown in FIG. 17, a size of the portions of the one surface of the first magnetic body 711 and the one surface of the second magnetic body 731 facing each other and having opposite polarities may be greater than a size of the portions of the one surface of the first magnetic body 711 and the one surface of the second magnetic body 731 facing each other and having the same polarity.

Accordingly, a magnitude of the attractive force acting between the first magnetic portion 710 and the second magnetic portion 730 may be greater than a magnitude of the repulsive force acting between the first magnetic portion 710 and the second magnetic portion 730.

When the one surface of the first magnetic body 711 facing the one surface of the second magnetic body 731 has a plurality of polarities, a length or a size of a portion having each polarity may be measured by applying a ferrofluid to the one surface of the first magnetic body 711. For example, since a neutral region is formed between the first polarity and the second polarity, the ferrofluid does not stick to the neutral region, but sticks only to the portions having the first polarity and the second polarity. Accordingly, the lengths or the sizes of the portions having the first polarity and the second polarity may be measured by measuring the portions to which the ferrofluid sticks.

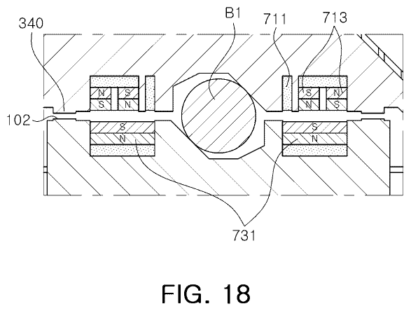

FIG. 18 is a view illustrating an attractive force and a repulsive force acting between a holder and a housing according to another embodiment.

Referring to FIG. 18, there is a difference in the structure for generating the attractive force and the repulsive force between the holder 330 and the housing 100 compared to the embodiment illustrated in FIG. 17.

The first magnetic portion 710 includes a first magnetic body 711 and a third magnetic body 713, and the second magnetic portion 730 includes a second magnetic body 731.

The first magnetic body 711 may be disposed on the holder 330, the second magnetic body 731 may be disposed on the housing 100, and the third magnetic body 713 may be disposed on the holder 330. That is, both the first magnetic body 711 and the third magnetic body 713 may be disposed on the holder 330, and the second magnetic body 731 may be disposed on the housing 100.

The first magnetic body 711 and the third magnetic body 713 may be spaced apart from each other in the first optical axis (Y-axis) direction. In an embodiment, the first magnetic body 711 may be disposed closer to the first ball member B1 (i.e., the intersection of the plurality of rotation axes) than the third magnetic body 713. In an embodiment illustrated in FIG. 18, the first magnetic body 711 may be a yoke, and each of the second magnetic body 731 and the third magnetic body 713 may be a magnet.

One surface of the first magnetic body 711 and one surface of the second magnetic body 731 may be disposed to face each other in the first optical axis (Y-axis) direction, and one surface of the second magnetic body 731 may have one polarity (a first polarity or a second polarity).

Accordingly, an attractive force may act between the first magnetic body 711 disposed on the holder 330 and the second magnetic body 731 disposed on the housing 100.

One surface of the third magnetic body 713 and one surface of the second magnetic body 731 may be disposed to face each other in the first optical axis (Y-axis) direction.

A number of polarities on the one surface of the third magnetic body 713 facing the one surface of the second magnetic body 731 may be different from a number of polarities on the one surface of the second magnetic body 731 facing the one surface of the third magnetic body 713.

In an embodiment, the third magnetic body 713 may be a polarized magnet in which the one surface of the third magnetic body 713 facing the one surface of the second magnetic body 731 has a plurality of polarities. That is, a plurality of polarities including opposite polarities may be formed on the one surface of the third magnetic body 713 facing the one surface of the second magnetic body 731. The second magnetic body 731 may be a unipolar magnet in which the one surface of the second magnetic body 731 facing the one surface of the third magnetic body 713 has one polarity.

For example, the one surface of the third magnetic body 713 facing the one surface of the second magnetic body 731 is magnetized to have both the first polarity and the second polarity, and the one surface of the second magnetic body 731 facing the one surface of the third magnetic body 713 is magnetized to have one polarity (the first polarity or the second polarity).

Accordingly, both an attractive force and a repulsive force act between the third magnetic body 713 and the second magnetic body 731.

In an embodiment, the one surface of the third magnetic body 713 facing the one surface of the second magnetic body 731 has the first polarity in a portion closer to the first ball member B1 (i.e., the intersection of the plurality of rotation axes) (i.e., a portion closer to the first magnetic body 711), and has the second polarity in a portion farther from the first ball member B1 (i.e., a portion farther from the first magnetic body 711). Additionally, the one surface of the second magnetic body 731 facing the one surface of the third magnetic body 713 has the second polarity.

Accordingly, a region in which the attractive force is generated may be an inner region among the portions of the one surface of the third magnetic body 713 and the one surface of the second magnetic body 731 facing each other, and a region in which the repulsive force is generated may be an outer region among the portions of the one surface of the third magnetic body 713 and the one surface of the second magnetic body 731 facing each other.

Although not shown in FIG. 18, in an embodiment, a distance between the one surface of the first magnetic body 711 and the one surface of the second magnetic body 731 may be different from a distance between the one surface of the third magnetic body 713 and the one surface of the second magnetic body 731 facing each other.

For example, a distance in the first optical axis (Y-axis) direction between the one surface of the first magnetic body 711 and the one surface of the second magnetic body 731 facing each other may be smaller than a distance in the first optical axis (Y-axis) direction between the one surface of the third magnetic body 713 and the one surface of the second magnetic body 731 facing each other.

Accordingly, a magnitude of the attractive force acting between the holder 330 and the housing 100 may be greater than a magnitude of the repulsive force acting between the holder 330 and the housing 100.

In an embodiment, a sum of a length in a direction perpendicular to the first optical axis (Y-axis) of the one surface of the first magnetic body 711 facing the one surface of the second magnetic body 731 and a length in the direction perpendicular to the first optical axis (Y-axis) of the portion having the first polarity of the one surface of the third magnetic body 713 facing the one surface of the second magnetic body 731 may be greater than a length in the direction perpendicular to the first optical axis (Y-axis) of the portion having the second polarity of the one surface of the third magnetic body 713 facing the one surface of the second magnetic body 731.

In an embodiment, a sum of a size of the one surface of the first magnetic body 711 facing the one surface of the second magnetic body 731 and a size of the portion having the first polarity of the one surface of the third magnetic body 713 facing the one surface of the second magnetic body 731 may be greater than a size of the portion having the second polarity of the one surface of the third magnetic body 713 facing the one surface of the second magnetic body 731.

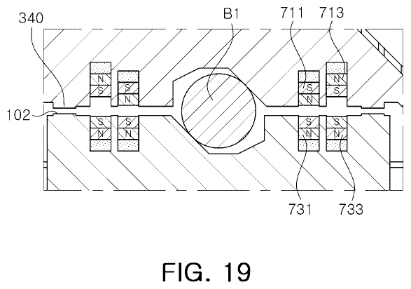

FIG. 19 is a view illustrating an attractive force and a repulsive force acting between a holder and a housing according to another embodiment.

Referring to FIG. 19, the first magnetic portion 710 includes a first magnetic body 711 and a third magnetic body 713, and the second magnetic portion 730 includes a second magnetic body 731 and a fourth magnetic body 733.

The first magnetic body 711 may be disposed on the holder 330, the second magnetic body 731 may be disposed on the housing 100, the third magnetic body 713 may be disposed on the holder 330, and the fourth magnetic body 733 may be disposed on the housing 100. That is, each of the first magnetic body 711 and the third magnetic body 713 may be disposed on the holder 330, and each of the second magnetic body 731 and the fourth magnetic body 733 may be disposed on the housing 100.

The first magnetic body 711 may be disposed closer to the first ball member B1 (i.e., the intersection of the plurality of rotation axes) than the third magnetic body 713. Additionally, the second magnetic body 731 may be disposed closer to the first ball member B1 than the fourth magnetic body 733.

In the embodiment illustrated in FIG. 19, each of the first magnetic body 711, the second magnetic body 731, the third magnetic body 713, and the fourth magnetic body 733 may be a magnet.

One surface of the first magnetic body 711 and one surface of the second magnetic body 731 are disposed to face each other in the first optical axis (Y-axis) direction, and each of the one surface of the first magnetic body 711 and the one surface of the second magnetic body 731 facing each other may have one polarity.

Here, a polarity of the one surface of the first magnetic body 711 and a polarity of the one surface of the second magnetic body 731 facing each other may be opposite to each other. For example, when the one surface of the first magnetic body 711 facing the one surface of the second magnetic body 731 has the first polarity, the one surface of the second magnetic body 731 facing the first magnetic body 711 may have the second polarity.

The first polarity and the second polarity are opposite polarities, and when the first polarity is an N-pole, the second polarity may be an S-pole.

Accordingly, an attractive force may act between the first magnetic body 711 disposed on the holder 330 and the second magnetic body 731 disposed on the housing 100.

One surface of the third magnetic body 713 and one surface of the fourth magnetic body 733 are disposed to face each other in the first optical axis (Y-axis) direction, and each of the one surface of the third magnetic body 713 and the one surface of the fourth magnetic body 733 facing each other may have one polarity.

Here, a polarity of the one surface of the third magnetic body 713 and a polarity of the one surface of the fourth magnetic body 733 facing each other may be the same polarity. For example, when the one surface of the third magnetic body 713 facing the one surface of the fourth magnetic body 733 has the second polarity, the one surface of the fourth magnetic body 733 facing the one surface of the third magnetic body 713 may also have the second polarity.

Accordingly, a repulsive force may act between the third magnetic body 713 disposed on the holder 330 and the fourth magnetic body 733 disposed on the housing 100.

A distance between the one surface of the first magnetic body 711 and the one surface of the second magnetic body 731 facing each other may be different from a distance between the one surface of the third magnetic body 713 and the one surface of the fourth magnetic body 733 facing each other.

For example, a distance in the first optical axis (Y-axis) direction between the one surface of the first magnetic body 711 and the one surface of the second magnetic body 731 facing each other may be smaller than a distance in the first optical axis (Y-axis) direction between the one surface of the third magnetic body 713 and the one surface of the fourth magnetic body 733 facing each other.

Accordingly, a magnitude of the attractive force acting between the first magnetic body 711 and the second magnetic body 731 may be greater than a magnitude of the repulsive force acting between the third magnetic body 713 and the fourth magnetic body 733.

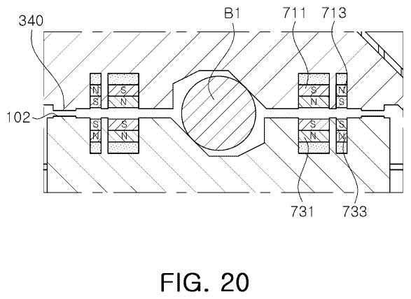

FIG. 20 is a view illustrating an attractive force and a repulsive force acting between a holder and a housing according to another embodiment.

An embodiment illustrated in FIG. 20 has a difference in sizes of the first magnetic body 711, the second magnetic body 713, the third magnetic body 731, and the fourth magnetic body 733 compared to the embodiment illustrated in FIG. 19.

A size of the one surface of the first magnetic body 711 and the one surface of the second magnetic body 731 facing each other may be different from a size of the one surface of the third magnetic body 713 and the one surface of the fourth magnetic body 733 facing each other.

For example, the size of the one surface of the first magnetic body 711 and the one surface of the second magnetic body 731 facing each other may be greater than the size of the one surface of the third magnetic body 713 and the one surface of the fourth magnetic body 733 facing each other.

That is, a region in which surfaces having opposite polarities face each other may be larger than a region in which surfaces having the same polarity face each other.

A length of the one surface of the first magnetic body 711 and the one surface of the second magnetic body 731 facing each other may be different from a length of the one surface of the third magnetic body 713 and the one surface of the fourth magnetic body 733 facing each other.

For example, the length of the one surface of the first magnetic body 711 and the one surface of the second magnetic body 731 facing each other may be greater than the length of the one surface of the third magnetic body 713 and the one surface of the fourth magnetic body 733 facing each other. Here, the lengths are lengths in a direction perpendicular to the first optical axis (Y-axis).

Accordingly, a magnitude of the attractive force acting between the first magnetic body 711 and the second magnetic body 731 may be greater than a magnitude of the repulsive force acting between the third magnetic body 713 and the fourth magnetic body 733.

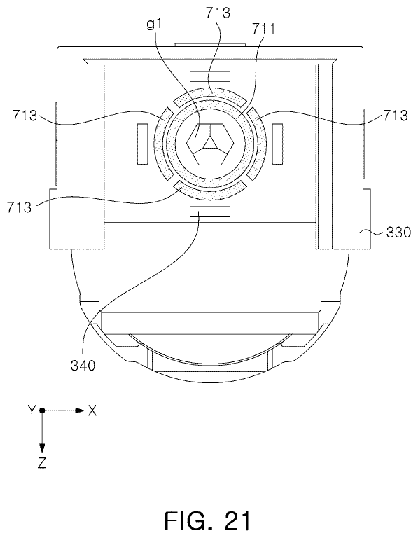

FIG. 21 is a bottom view of a holder according to another embodiment.

Referring to FIG. 21, the first magnetic body 711 and the third magnetic body 713 disposed on the holder 330 may have different shapes.

In an embodiment, the first magnetic body 711 may have a closed curve shape completely surrounding the first guide groove g1, and the third magnetic body 713 may have an open curve shape partially surrounding the first guide groove g1. That is, the third magnetic body 713 may have a shape in which a closed curve shape surrounding the first guide groove g1 is cut into a plurality of open curve segment shapes partially surrounding the first guide groove g1.

For example, when viewed in the first optical axis (Y-axis) direction, the first magnetic body 711 may have a closed curved shape completely surrounding the first guide groove g1, and the third magnetic body 713 may be a combination of a plurality of magnetic bodies having open curve segment shapes partially surrounding the first guide groove g1.

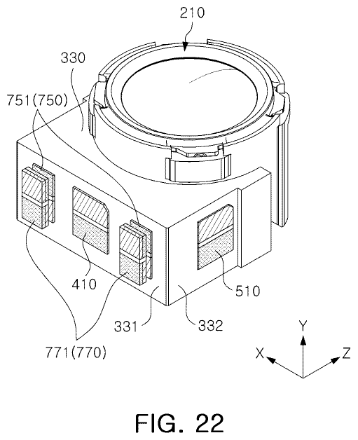

FIG. 22 is a view illustrating a repulsive force acting on a reflection module.

Referring to FIG. 22, a repulsive force may act between the holder 330 and the housing 100. For example, the repulsive force may act in the second optical axis (Z-axis) direction.

The reflection module 300 includes a third magnetic portion 750 and a fourth magnetic portion 770.

The third magnetic portion 750 may include a plurality of fifth magnetic bodies 751, and the plurality of fifth magnetic bodies 751 may be spaced apart from each other. Each of the plurality of fifth magnetic bodies 751 may be a magnet.

The fourth magnetic portion 770 may include a plurality of sixth magnetic bodies 771, and the plurality of sixth magnetic bodies 771 may be spaced apart from each other. Each of the plurality of sixth magnetic bodies 771 may be a magnet.

The third magnetic portion 750 may be disposed on the holder 330, and the fourth magnetic portion 770 may be disposed on the housing 100. The third magnetic portion 750 and the fourth magnetic portion 770 may be disposed to face each other.

As illustrated in FIG. 22, the plurality of fifth magnetic bodies 751 of the third magnetic portion 750 may be spaced apart from each other in the first axis (X-axis) direction, and may be disposed on the first side surface 331 of the holder 330. The first magnet 410 may be disposed between the plurality of fifth magnetic bodies 751.

The plurality of sixth magnetic bodies 771 of the fourth magnetic portion 770 may be spaced apart from each other in the first axis (X-axis) direction, and may be disposed on the housing 100.

The plurality of fifth magnetic bodies 751 of the third magnetic portion 750 and the plurality of sixth magnetic bodies 771 of the fourth magnetic portion 770 may face each other in the second optical axis (Z-axis) direction.

Additionally, surfaces of the plurality of fifth magnetic bodies 751 and surfaces of the plurality of sixth magnetic bodies 771 facing each other may be configured to have the same polarity.

Accordingly, a repulsive force acts between the third magnetic portion 750 and the fourth magnetic portion 770.

Referring to FIG. 22, each of the plurality of fifth magnetic bodies 751 may be a polarized magnet in which each surface thereof has both the first polarity and the second polarity. Additionally, each of the plurality of sixth magnetic bodies 771 may be a polarized magnet in which each surface thereof has both the first polarity and the second polarity.

In another embodiment, each of the plurality of fifth magnetic bodies 751 may be a unipolar magnet in which each surface thereof has one polarity. Additionally, each of the plurality of sixth magnetic bodies 771 may also be a unipolar magnet in which each surface thereof has one polarity.

As the holder 330 rotates around the first optical axis (Y-axis) as the rotation axis during the shake correction, a distance between some of the plurality of fifth magnetic bodies 751 of the third magnetic portion 750 on one side of the first magnet 410 and some of the plurality of sixth magnetic bodies 771 of the fourth magnetic portion 770 on the one side of the first magnet 410 decreases, causing the repulsive force between the some of the plurality of fifth magnetic bodies 751 and the some of the plurality of sixth magnetic bodies 771 to increase, thereby causing the holder 330 to return to an original position when power is not applied to the reflection module 300.

Here, the original position refers to a state in which the holder 330 is not rotated about the first optical axis (Y-axis), for example, a state in which the third magnetic portion 750 and the fourth magnetic portion 770 are parallel to each other.

That is, the reflection module 300 according to an embodiment of the present disclosure may reduce power consumption for positioning the holder 330 by mechanically implementing a centering structure of the holder 330.

Accordingly, in a case in which shake correction is not required (for example, when power is not applied to the reflection module 300), a position of the holder 330 may be adjusted without separate power consumption.

As discussed above, FIG. 22 illustrates an embodiment in which the plurality of fifth magnetic bodies 751 of the third magnetic portion 750 are spaced apart from each other in the first axis (X-axis) direction and are disposed on the first side surface 331 of the holder 330.

Alternatively, the plurality of fifth magnetic bodies 751 of the third magnetic portion 750 may also be spaced apart from each other in the second optical axis (Z-axis) direction and may be disposed on the second side surface 332 or the third side surface 333 of the holder 330 (see FIG. 6). In this case, the plurality of fifth magnetic bodies 751 of the third magnetic portion 750 and the plurality of sixth magnetic bodies 771 of the fourth magnetic portion 770 may face each other in the first axis (X-axis) direction.

Additionally, the second magnet 510 or the third magnet 610 may be disposed between the plurality of fifth magnetic bodies 751.

The reflection module 300 may detect the position of the holder 330. For this purpose, a plurality of position sensors are provided. The plurality of position sensors include a first position sensor 430, a second position sensor 530, and a third position sensor 630.

Referring to FIGS. 5 and 6, the first position sensor 430 may be disposed to face the first magnet 410. The second position sensor 530 may be disposed to face the second magnet 510. The third position sensor 630 may be disposed to face the third magnet 610.

The first position sensor 430, the second position sensor 530, and the third position sensor 630 may be disposed on the substrate 900.

When the holder 330 is rotated about the first axis (X-axis) as a rotation axis, the position of the holder 330 may be detected by the first position sensor 430.

When the holder 330 is rotated about the second optical axis (Z-axis) as a rotation axis, the position of the holder 330 may be detected by the second position sensor 530.

When the holder 330 is rotated about the first optical axis (Y-axis) as a rotation axis, the position of the holder 330 may be detected by the third position sensor 630.

Each of the first position sensor 430, the second position sensor 530, and the third position sensor 630 may be a Hall sensor.

Referring to FIG. 2, a spacer 212 may be disposed on a lower surface of the first lens module 210 (i.e., a lower surface of the first lens barrel 211 facing the reflection member 310). The spacer 212 has an entrance hole through which light passes, and the entrance hole may be non-circular. For example, the entrance hole may be oval-shaped, like a running track. That is, an inner surface of the spacer 212 forming the entrance hole may include two planes extending parallel to each other, and two curved surfaces connecting the two planes to each other.

The inner surface of the spacer 212 may have a corrugated shape in which concave and convex shapes are repeated to prevent a flare phenomenon caused by stray light from occurring.

Referring to FIG. 7, the reflection module 300 may include first stoppers 340 and 102. The first stoppers 340 and 102 may protrude from surfaces of the holder 330 and the housing 100 facing each other in the first optical axis (Z-axis) direction.

In an embodiment, the first stopper 340 may be disposed on a lower surface of the holder 330, and the first stopper 340 may be disposed on an upper surface of the protrusion portion 101 of the housing 100.

The first stopper 340 of the holder 330 and the first stopper 102 of the housing 100 may face each other in the first optical axis (Y-axis) direction.

Accordingly, a rotation range of the holder 330 may be limited by the first stoppers 340 and 102, and thus, the first magnetic portion 710 disposed on the holder 330 and the second magnetic portion 730 disposed on the housing 100 may be prevented from colliding with each other.

Additionally, damage to the holder 330 may be prevented by allowing the first stoppers 340 and 102 to come into contact with each other when the camera module 1 is subjected to external impacts.

An elastic buffer member (not shown) may be coupled to the first stoppers 340 and 102. Accordingly, impacts may be buffered.

Although the first stoppers 340 and 102 are described as being disposed on each of the holder 330 and the housing 100, the first stoppers 340 and 102 may also be formed on only one of the holder 330 and the housing 100.

Referring to FIG. 2, the reflection module 300 may include a second stopper 350. The second stopper 350 may be coupled to the housing 100 to cover at least a portion of the holder 330. For example, the second stopper 350 may cover at least a portion of the upper surface of the holder 330.

The second stopper 350 and the holder 330 may be spaced apart from each other in the first optical axis (Y-axis) direction. Additionally, the second stopper 350 and the holder 330 may be spaced apart from each other in the first axis (X-axis) direction.

Accordingly, it may be possible to prevent the holder 330 from being separated from the housing 100 due to external impacts and other disturbances without impeding the rotation of the holder 330.

A buffer member 351 having elasticity may be coupled to the second stopper 350. The buffer member 351 may be disposed on either one both of one surface and another surface of the second stopper 350. The one surface of the second stopper 350 may be a surface facing the case 110 in the first optical axis (Y-axis) direction, and the other surface of the second stopper 350 may be a surface facing the holder 330 in the first optical axis (Y-axis) direction.

Additionally, the buffer member 351 may also be disposed on a side surface of the second stopper 350. The side surface of the second stopper 350 may be a surface facing the holder 330 in the second optical axis (Z-axis) direction.

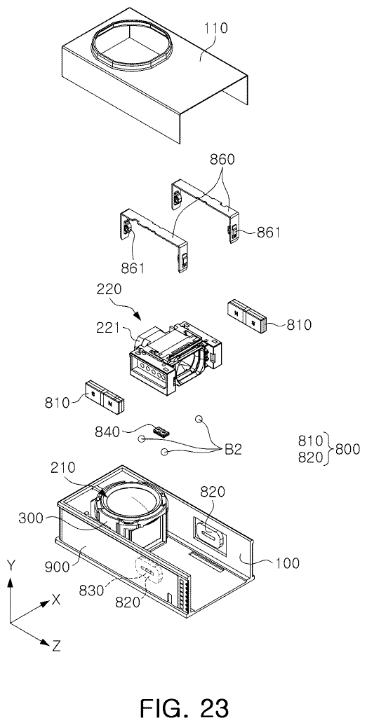

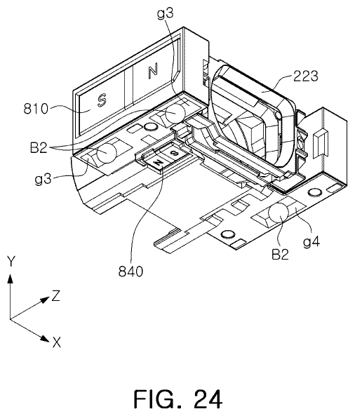

FIG. 23 is a perspective view illustrating a state in which a second lens module is separated from a camera module according to an embodiment of the present disclosure, and FIG. 24 is a bottom perspective view of the second lens module of FIG. 23.

Referring to FIG. 23, a second lens module 220 may be disposed between the reflection module 300 and an image sensor module (not shown).

The second lens module 220 may be moved in the second optical axis (Z-axis) direction for focus adjustment.

In an embodiment, the second lens module 220 includes a plurality of lenses and a second lens barrel 221. The plurality of lenses may be disposed inside the second lens barrel 221.

The camera module 1 may include a fourth driver 800 to move the second lens module 220 in the second optical axis (Z-axis) direction.

The fourth driver 800 includes a fourth magnet 810 and a fourth coil 820. The fourth magnet 810 and the fourth coil 820 may be disposed to face each other in a direction perpendicular to the second optical axis (Z-axis) direction (i.e., in the first axis (X-axis) direction).

The fourth magnet 810 is disposed on the second lens module 220. For example, the fourth magnet 810 may be disposed on a side surface of the second lens module 220.

In an embodiment, the fourth magnet 810 may include two magnets, and one magnet may be mounted on each of one side surface and another side surface of the second lens module 220. The one side surface and the other side surface of the second lens module 220 may be spaced apart from each other in the first axis (X-axis) direction.

The fourth magnet 810 may be magnetized so that one surface (e.g., a surface facing the fourth coil 820) has both an N-pole and an S-pole. For example, the one surface of the fourth magnet 810 facing the fourth coil 820 may be provided with an N-pole, a neutral region, and an S-pole sequentially arranged in the second optical axis (Z-axis) direction.

The fourth coil 820 is disposed to face the fourth magnet 810. For example, the fourth coil 820 may be disposed to face the fourth magnet 810 in a direction perpendicular to the second optical axis (Z-axis) direction (i.e., in the first axis (X-axis) direction).

The fourth coil 820 is disposed on the substrate 900, and the substrate 900 is mounted on the housing 100 so that the fourth magnet 810 and the fourth coil 820 face each other in the first axis (X-axis) direction. In an embodiment, the fourth coil 820 may include two coils spaced apart from each other in the first axis (X-axis) direction each facing a respective one of two magnets of the fourth magnet 810.

The housing 100 may be provided with a through-hole penetrating through the housing 100, and the fourth coil 820 disposed on the substrate 900 may directly face the fourth magnet 810 through the through-hole.

When adjusting the focus, the fourth magnet 810 is a moving member mounted on the second lens module 220 and moving in the second optical axis (Z-axis) direction along with the second lens module 220, and the fourth coil 820 is a fixed member fixed to the substrate 900.

When power is applied to the fourth coil 820, the second lens module 220 may be moved in the second optical axis (Z-axis) direction by an electromagnetic force generated between the fourth magnet 810 and the fourth coil 820.

A second ball member B2 may be disposed between the second lens module 220 and the housing 100, and the second lens module 220 may be guided by the second ball member B2 and may be moved in the second optical axis (Z-axis) direction. The second ball member B2 includes a plurality of balls.

A pulling magnet 840 is disposed on a lower surface of the second lens module 220, and a pulling yoke (not shown) may be disposed on the inner bottom surface of the housing 100. In another embodiment, a pulling magnet 840 may be disposed on both the second lens module 220 and the housing 100.

The pulling magnet 840 may be disposed close to the one side surface of the second lens module 220. That is, the pulling magnet 840 may be disposed closer to the one side surface of the second lens module 220 than to the other side surface of the second lens module 220 in the first axis (X-axis) direction. Additionally, the pulling magnet 840 may be disposed between the one side surface of the second lens module 220 and the second optical axis (Z-axis).

The pulling magnet 840 and the pulling yoke may be disposed to face each other in the first optical axis (Y-axis) direction.

The pulling magnet 840 and the pulling yoke may generate an attractive force between each other. For example, the attractive force acts between the pulling magnet 840 and the pulling yoke in the first optical axis (Y-axis) direction.

The second ball member B2 may be held in contact with the second lens module 220 and the housing 100 by the attractive force between the pulling magnet 840 and the pulling yoke.

Some of the plurality of balls of the second ball member B2 may be disposed close to one side surface of the second lens module 220, and a remainder of the plurality of balls of the second ball member B2 may be disposed close to the other side surface of the second lens module 220 in the first axis (X-axis) direction). The number of balls disposed between the one side surface of the second lens module 220 and the second optical axis (Z-axis) may be greater than the number of balls disposed between the other side surface of the second lens module 220 and the second optical axis (Z-axis).

In an embodiment, the second ball member B2 may include at least three balls. When the second ball member B2 includes three balls, two of the three balls may be disposed between the one side surface of the second lens module 220 and the second optical axis (Z-axis), and a remaining one of the three balls may be disposed between the other side surface of the second lens module 220 and the second optical axis (Z-axis).

The two balls disposed between the one side surface of the second lens module 220 and the second optical axis (Z-axis) may be spaced apart from each other in the second optical axis (Z-axis) direction.

A third guide groove g3 and a fourth guide groove g4 may be formed in at least one of surfaces of the second lens module 220 and the housing 100 facing each other. For example, the third guide groove g3 may be formed in the lower surface of the second lens module 220 near the one side surface of the second lens module 220, and the fourth guide groove g4 may be formed in the lower surface of the second lens module 220 near the other side surface of the second lens module 220.

The third guide groove g3 and the fourth guide groove g4 may be spaced apart from each other in a direction perpendicular to the second optical axis (Z-axis) (for example, in the first axis (X-axis) direction).

The third guide groove g3 and the fourth guide groove g4 extend in a direction parallel to the second optical axis (Z-axis).

Some of the plurality of balls of the second ball member B2 are disposed in the third guide groove g3, and a remainder of the plurality of balls of the second ball member B2 are disposed in the fourth guide groove g4.

A number of contact points between the some of the plurality of balls of the second ball member B2 and the third guide groove g3 is greater than a number of contact points between the remainder of the plurality of balls of the second ball member B2 and the fourth guide groove g4.

The third guide groove g3 is disposed closer to the one side surface of the second lens module 220 than the fourth guide groove g4, and the fourth guide groove g4 is disposed closer to the other side surface of the second lens module 220 than the third guide groove.

The pulling magnet 840 may be disposed closer to the third guide groove g3 than to the fourth guide groove g4.

In an embodiment, the camera module 1 may detect a position of the second lens module 220. For this purpose, a fourth position sensor 830 is provided. The fourth position sensor 830 may be disposed at a position facing the fourth magnet 810 of the fourth driver 800 (for example, a position facing the fourth magnet 810 in the first axis (X-axis) direction).

Accordingly, when the second lens module 220 moves in the second optical axis (Z-axis) direction, the position of the second lens module 220 may be detected by the fourth position sensor 830.

The fourth position sensor 830 may be a Hall sensor.

The second lens module 220 may further include a light shielding plate 223. The light shielding plate 223 may be coupled to the second lens module 220.

The side surface and the other side surface of the second lens module 220 may be formed to extend away from the second lens module 220 in the second optical axis (Z-axis) direction. A portion of the one side surface of the second lens module 220 and a portion of the other side surface of the second lens module 220 may face each other in the first axis (X-axis) direction. A space may be formed between the portion of the one side surface of the second lens module 220 and the portion of the other side surface of the second lens module 220 facing each other in the first axis (X-axis) direction.

The light shielding plate 223 may be disposed in the space between the portion of the one side surface of the second lens module 220 and the portion of the other side surface of the second lens module 220 facing each other in the first axis (X-axis) direction.

The light shielding plate 223 prevents light passing through the second lens module 220 from causing unintended reflection inside the housing 100. Accordingly, a flare phenomenon may be suppressed.

The camera module 1 may further include a third stopper 860. The third stopper 860 may be coupled to the housing 100 and may cover at least a portion of the second lens module 220.

In an embodiment, the third stopper 860 may be disposed to face an upper surface of the second lens module 220 in the first optical axis (Y-axis) direction. One side and another other side of the third stopper 860 may be bent and extended in the first optical axis (Y-axis) direction to face the second lens module 220 in the second optical axis (Z-axis) direction.

An elastic buffer member 861 may be coupled to the third stopper 860. For example, a buffer member 861 may be mounted on the one side and the other side of the third stopper 860 facing the second lens module 220 in the second optical axis (Z-axis) direction.

Additionally, a buffer member (not shown) may be mounted on either one or both of a surface of the third stopper 860 and a surface of the second lens module 220 facing each other in the first optical axis (Y-axis) direction.

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflection module comprising:
a housing;
a holder disposed in the housing and configured to be rotatable relative to the housing;
a first magnetic portion disposed on one surface of the holder; and
a second magnetic portion disposed on one surface of the housing and facing the first magnetic portion,
wherein both an attractive force and a repulsive force act between the first magnetic portion and the second magnetic portion.

2. The reflection module of claim 1, wherein a gap between the first magnetic portion and the second magnetic portion changes as the holder rotates.

3. The reflection module of claim 1, wherein the holder is further configured to be rotatable about at least two axes perpendicular to a direction in which the first magnetic portion and the second magnetic portion face each other, and perpendicular to each other, as rotation axes.

4. The reflection module of claim 1, wherein a position at which the attractive force acts is closer to a rotation center of the holder than a position at which the repulsive force acts.

5. The reflection module of claim 1, wherein the first magnetic portion comprises a first magnetic body and a third magnetic body both disposed on the holder,
the second magnetic portion comprises a second magnetic body disposed on the housing, and
each of the first magnetic body, the second magnetic body, and the third magnetic body is a magnet.

6. The reflection module of claim 5, wherein one surface of the first magnetic body and one surface of the second magnetic body face each other,
one surface of the third magnetic body and the one surface of the second magnetic body face each other,
the one surface of the first magnetic body and the one surface of the second magnetic body facing each other have different polarities, and
the one surface of the third magnetic body and the one surface of the second magnetic body facing each other have a same polarity.

7. The reflection module of claim 6, wherein a distance between the one surface of the first magnetic body and the one surface of the second magnetic body is smaller than a distance between the one surface of the third magnetic body and the one surface of the second magnetic body.

8. The reflection module of claim 6, wherein a size of portions of the one surface of the first magnetic body and the one surface of the second magnetic body facing each other is larger than a size of portions of the one surface of the third magnetic body and the one surface of the second magnetic body facing each other.

9. The reflection module of claim 1, wherein a magnitude of the attractive force is greater than a magnitude of the repulsive force.

10. The reflection module of claim 1, wherein the first magnetic portion comprises a first magnetic body and a third magnetic body both disposed on the holder,
the second magnetic portion comprises a second magnetic body disposed on the housing,
the first magnetic body is a yoke,
each of the second magnetic body and the third magnetic body is a magnet, and
the attractive force acts between the first magnetic body and the second magnetic body, and the repulsive force acts between the third magnetic body and the second magnetic body.

11. The reflection module of claim 1, wherein the first magnetic portion comprises a first magnetic body disposed on the holder,
the second magnetic portion comprises a second magnetic body disposed on the housing,
each of the first magnetic body and the second magnetic body is a magnet,
one surface of the first magnetic body and one surface of the second magnetic body face each other, and
a number of polarities of the one surface of the first magnetic body and a number of polarities of the one surface of the second magnetic body facing each other are different from each other.

12. The reflection module of claim 11, wherein a first portion of the one surface of the first magnetic body and a first portion of the one surface of the second magnetic body facing each other have opposite polarities,
a second portion of the one surface of the first magnet body and a second portion of the one surface of the second magnetic body facing each other have a same polarity, and
a size of the first portions is greater than a size of the second portions.

13. The reflection module of claim 1, further comprising:
a third magnetic portion disposed on another surface of the holder; and
a fourth magnetic portion disposed on another surface of the housing and facing the third magnetic portion,
wherein a repulsive force acts between the third magnetic portion and the fourth magnetic portion.

14. The reflection module of claim 13, wherein a direction in which the first magnetic portion and the second magnetic portion face each other and a direction in which the third magnetic portion and the fourth magnetic portion face each other are perpendicular to each other.

15. The reflection module of claim 1, further comprising a first ball member disposed between the housing and the holder.

16. The reflection module of claim 15, wherein the first magnetic portion comprises a first magnetic body disposed on the holder,
the second magnetic portion comprises a second magnetic body disposed on the housing, and
each of the first magnetic body and the second magnetic body has a ring shape surrounding the first ball member.

17. The reflection module of claim 15, wherein a first guide groove is formed in the holder,
a second guide groove is formed in the housing, and
the first ball member is disposed in three-point contact with the first guide groove and in three-point contact with the second guide groove.

18. A camera module comprising:
a housing;
a holder disposed in the housing and configured to be rotatable relative to the housing;
an optical member coupled to the holder;
a support portion disposed in the housing between the housing and the holder and configured to rotatably support the holder;
a first magnetic portion disposed on the holder; and
a second magnetic portion disposed on the housing and facing the first magnetic portion,
wherein a repulsive force acts between the first magnetic portion and the second magnetic portion.

19. The camera module of claim 18, wherein in addition to the repulsive force acting between the first magnetic portion and the second magnetic portion, an attractive force acts between the first magnetic portion and the second magnetic portion, and
a position at which the attractive force acts is closer to a rotation center of the holder than a position at which the repulsive force acts.

20. The camera module of claim 19, further comprising:
a first driver comprising a first magnet disposed on the holder and a first coil facing the first magnet; and
a second driver comprising a second magnet disposed on the holder and a second coil facing the second magnet.

21. The camera module of claim 18, further comprising a first lens module coupled to the holder and having a first optical axis,
wherein the optical member is a reflection member, and
the first magnetic portion and the second magnetic portion face each other in a direction of the first optical axis.

22. A reflection module comprising:
a housing;
a holder disposed in the housing and configured to be rotatable relative to the housing from an original position to perform shake correction;
a first magnetic portion disposed on one surface of the holder; and
a second magnetic portion disposed on one surface of the housing and facing the first magnetic portion,
wherein the first magnetic portion and the second magnetic portion are configured to return the housing to the original position after the shake correction has been performed.

23. The reflection module of claim 22, wherein both an attractive force and a repulsive force act between the first magnetic portion and the second magnetic portion in a direction in which the first magnetic portion and the second magnetic portion face each other.

24. The reflection module of claim 23, wherein the holder is further configured to be rotatable about at least two axes perpendicular to a direction in which the first magnetic portion and the second magnetic portion face each other, and perpendicular to each other, as rotation axes to perform the shake correction, and
a position at which the attractive force acts is closer to a rotation center of the holder than a position at which the repulsive force acts.

25. The reflection module of claim 24, wherein a gap between the first magnetic portion and the second magnetic portion decreases on one side of the rotation center of the holder as the holder rotates away from the original position during the shake correction, thereby causing the repulsive force to increase on the one side of the holder during the shake correction, and
the increased repulsive force acts to return the holder to the original position after the shake correction has been performed.
